(19) United States
(12) Patent Application Publication
(10) Pub. No.: US 2023/0010076 A1
(43) Pub. Date: Jan. 12, 2023

(54) METHOD OF MOULDING AND MOULD TOOL

(71) Applicant: SURFACE GENERATION LIMITED, RUTLAND (GB)

(72) Inventor: Ben HALFORD, RUTLAND (GB)

(21) Appl. No.: 17/784,813

(22) PCT Filed: Dec. 14, 2020
(86) PCT No.: PCT/EP2020/085920

§ 371 Date: Jun. 13, 2022

(30) Foreign Application Priority Data
Dec. 13, 2019 (GB) 1918398.7

(51) Int. Cl. B29C 45/26; B29C 45/73; B29C 45/78; B29C 45/80

(52) U.S. Cl. CPC B29C 45/2606; B29C 45/7337; B29C 45/78; B29C 45/80; B29C 2045/7343; B29C 2945/76096; B29C 2945/76257; B29C 2945/76461; B29C 2945/76488; B29C 2945/76531

(57) ABSTRACT

A mould tool comprising: a first tool part defining a first mould cavity portion; a second tool part defining a second mould cavity portion; and, a cavity alignment system comprising: a temperature control system configured to control the temperature of a first zone of the first tool part to thereby effect thermal expansion and/or contraction in the first zone of the first tool part; a sensor configured to measure movement of a part of the first tool part in response to the said thermal expansion and/or contraction; and, a controller configured to control the temperature control system in response to feedback from the sensor to thereby control the position of the first mould cavity portion relative to the second mould cavity portion.

The present invention relates to a mould tool, and an associated method of moulding a workpiece. In particular, the present invention relates to a mould tool including a cavity alignment system and/or mould tool deformation control system. The present invention also relates to a mould tool including a position detection apparatus for sensing mould tool alignment or mould tool deformation.

Mould tools are well known in the art and provide selective application of heat and pressure to material (plastic, composite or metallic) inside a mould cavity to form a workpiece. Some known tools have the ability to vary temperature across the mould surface to closely control this process. Such mould tools are disclosed in the applicant's earlier patent applications published as WO2011/048365 and WO2013/021195.

In both cases, the mould surfaces of the tools are separated into a number of discrete tessellated or adjacent zones. Each zone can be individually heated or cooled by a heating/cooling means, and as such the resulting material properties of the workpiece can be closely controlled across the tool.

In WO2013/021195, the mould tool comprises a series or stack of layers, typically including:

a mould layer defining a mould profile on a mould surface, and having a temperature control surface against which hot or cool fluid can be directed to heat or cool each zone;

an exhaust layer for exhausting the spent heating/cooling fluid; and,

a utilities layer for housing the control and heating/cooling means.

The layers are insulated from one another. This means that the mould layer can remain ‘thermally agile’—i.e. having low thermal mass in order for the temperature to be quickly adjusted with the minimum transfer of thermal energy. The layered tool also allows the maintenance of a low temperature in the utilities layer to protect the delicate electronics therein.

In use, a material (such as a pre-preg composite green body) is placed between two opposing mould layers (on opposite sides of the tool) and enclosed in a mould cavity defined by the opposing mould profiles. Pressure is applied to the mould (typically in the order of MPa through the stack). The mould layer, under pressure, is heated and cooled according to a desired profile and subsequently removed once the desired properties have been obtained. This technology can also be applied in other forms of moulding, such as injection moulding (IM) where molten material is injected into the cavity under pressure after the mould is closed.

Alignment

Many consumer electronics components, such as mobile telephone casings, laptop components etc., are formed in this manner Increasingly, high-tech components are also being manufactured in this way. For such precise components, there is a need to ensure that the opposing mould parts are accurately aligned (for example within +/−200 nm) so that the mould profiles on each part of the mould tool are concentric. One example is the accurate manufacture of optical equipment, e.g. lenses, for which accurate geometrical reproduction is essential.

Known methods of accurately aligning the mould parts include the provision of mechanical features on the mould parts. One or more protrusions may be included on one of the mould parts, for example, with complimentary notches or indentations included on the other of the mould parts. The protrusions and indentations are positioned such that the protrusions are positioned within a respective indentation when the mould profiles are correctly aligned.

Any misalignment is corrected by the lateral force applied when the protrusions and indentations engage.

During use of such mould tools, the mechanical features can become worn. This has a detrimental effect on the accuracy with which the two mould parts can be aligned and, consequently, the position of the mould profiles and the precision of the component. Further misalignment causes more wear, which in turn causes further misalignment. This is particularly true in high pressure applications such as injection moulding.

Deformation/Deflection

Although the provision of a relatively light weight and thin mould layer has significant thermal advantages (in terms of its ‘agility’), one drawback is the potential for deformation to occur under the high pressures and temperatures experienced during the moulding process. Given that the mould layer is typically formed within a reasonably stiff outer perimeter, excessive pressures and thermal expansion can cause deformation of the mould layer in the mould closure/clamping direction (also known as the ‘Z’ direction).

This is generally undesirable as it can influence the shape of the moulded product.

It is an aim of the present invention to overcome or at least mitigate the above mentioned problems.

According to a first aspect of the present invention, there is provided a mould tool comprising:

a first tool part defining a first mould cavity portion;

a second tool part defining a second mould cavity portion, wherein at least one of the first and second tool parts is moveable towards and away from the other of the first and second tool parts in a mould closure direction such that the first and second mould cavity portions cooperate to define a mould cavity for moulding a workpiece; and,

a cavity alignment system comprising:

a temperature control system configured to control the temperature of a first zone of the first tool part to thereby effect thermal expansion and/or contraction in the first zone of the first tool part in a direction normal to the mould closure direction;

a sensor configured to measure movement of a part of the first tool part in response to the said thermal expansion and/or contraction in the first zone of the first tool part; and,

a controller configured to control the temperature control system in response to feedback from the sensor to thereby control the position of the first mould cavity portion relative to the second mould cavity portion in a direction normal to the mould closure direction.

Advantageously, the cavity alignment system enables changes in the position of one of the mould cavity portions relative to the other mould cavity portion to be measured and adjusted dynamically in order to ensure that the mould cavity portions, or profiles, are correctly aligned throughout the moulding process, including during cooling. The cavity alignment system is particularly advantageous as it enables the fine-tuning or adjustment of the mould cavity portions to be undertaken in real-time before and during the moulding cycle, thereby improving the accuracy of the moulded components without compromising the amount of time required for the moulding process.

The first zone of the first tool part is preferably spaced apart from the first mould cavity portion. In other words, the first zone does not overlap the first mould tool cavity portion when viewed from a mould closure direction. Advantageously, this means that expansion and contraction of the zone will primarily influence the position of the cavity, rather than the shape of the cavity.

At least one of the first and second tool parts are in contact on a contact plane normal to the mould closure direction, and the said thermal expansion and/or contraction in the first zone of the first tool part is in a direction parallel to the mould contact plane.

The temperature control system may also be configured to independently control the temperature of a second zone of the first tool part to thereby effect thermal expansion and/or contraction in the second zone of the first tool part. The sensor may be configured to measure movement of a second part of the first tool part in response to the said thermal expansion and/or contraction in the second zone of the first tool part. The said thermal expansion and/or contraction in the second zone of the first tool part may be in a direction that is normal, i.e. perpendicular, to the mould closure direction.

The direction of the said thermal expansion and/or contraction in the second zone of the first tool part may be different to the direction of the said thermal expansion and / or contraction in the first zone of the first tool part.

The direction of the said thermal expansion and/or contraction in the second zone of the first tool part may, for example, be normal, i.e. perpendicular, to the direction of the said thermal expansion and/or contraction in the first zone of the first tool part.

The second zone of the first tool part is preferably spaced apart from the first mould cavity portion. In other words, the second zone does not overlap the first mould tool cavity portion when viewed from a mould closure direction. Preferably, the second zone of the first tool part is perpendicular to the first mould cavity portion. Advantageously, this means that expansion and contraction of the zone will primarily influence the position of the cavity, rather than the shape of the cavity.

The sensor may comprise:

an emitter that is configured to emit a signal, said signal travelling along a signal path, the signal being influenced by the position of the first mould cavity portion relative to the second mould cavity portion; and

a detector that is configured to detect the signal, the detected signal being thereby indicative of the position of the first mould cavity portion relative to the second mould cavity portion.

By ‘influenced’ we mean the signal is somehow altered or repositioned—in other words a change occurs that can be detected. For example, the signal path may be influenced or altered to split, diffract, reflect or refract the signal, depending on the relative positions of the first and second mould cavity portions.

The emitter may be an electromagnetic emitter, the detector may be an electromagnetic detector and the signal may be an electromagnetic signal.

The emitter may be an optical emitter, the detector may be an optical detector and the signal may be an optical signal.

The sensor may further comprise:

a signal path modifier that is associated with the first tool part or the second tool part,

wherein the signal path modifier is positioned in the signal path between the emitter and the detector to thereby produce a variable signal at the detector, the variable signal being dependent on the position of the first mould cavity portion relative to the second mould cavity portion.

The emitter may be associated with the first tool part and the detector may be associated with the second tool part.

In some embodiments of the invention, the sensor may include more than one signal path modifier.

The signal path modifier may, for example, be one of two signal path modifiers, such that the sensor comprises:

a first signal path modifier that is associated with the first tool part, and

a second signal path modifier that is associated with the second tool part,

wherein the first and second signal path modifiers are positioned in the signal path between the emitter and the detector to thereby produce a variable signal at the detector, the variable signal being dependent on the position of the first mould cavity portion relative to the second mould cavity portion.

The first signal path modifier may be provided on a first surface of the first tool part and/or the second signal path modifier may be provided on a second surface of the second tool part.

Alternatively, the first signal path modifier may be formed in a first surface of the first tool part and/or the second signal path modifier may be formed in a second surface of the second tool part.

One or both of the signal path modifiers may be a plurality of openings or other regions being at least partially transparent to the signal. One or both of the signal path modifiers may comprise a plurality of substantially signal-transparent regions. The plurality of substantially signal-transparent regions may be openings. One or both of the signal path modifiers may be grates. One or both of the signal path modifiers may be lenses.

In alternative embodiments of the invention, each of the emitter and the detector may be associated with the first tool part and the signal path modifier may be associated with the second tool part.

A further signal path modifier may be associated with the first tool part.

One or both of the signal path modifier and the further signal path modifier may be an interface which changes the direction of the signal. One or both of the signal path modifier and the further signal path modifier may be a reflector.

The signal may be reflected more than one, for example more than twice, so that the length of the signal path is increased. Advantageously, this enables the signal to be magnified.

The first tool part may further include an anchor point by which the first tool part is fastened to the mould tool, and wherein the anchor point and the sensor are provided on opposite sides of the first mould cavity portion.

According to an alternative aspect of the present invention there is provided a method of aligning a mould tool, the method including the steps of:

providing a mould tool as defined by the first aspect of the invention;

using the sensor to sense the relative position of the first and second mould cavity portions; and

using the controller to control the temperature control system to adjust the position of the first mould cavity portion relative to the second mould cavity portion based on the sensed relative position.

The method may further include the steps of:

moving one of the first tool part and the second tool part towards the other of the first tool part and the second tool part such that the first tool part and the second part are in abutting contact;

using the sensor to sense the position of the first and second mould cavity portions; and

using the controller to control the temperature control system to adjust the position of the first mould cavity portion relative to the second mould cavity based on the sensed position, thereby defining an aligned mould cavity between the first and second tool parts.

The method may further include applying a moulding pressure to the first tool part and the second tool part when the first and second tool parts define the aligned mould cavity.

The method can be used to ensure that the mould cavity portions are accurately aligned before the moulding process is initiated. Furthermore, feedback on the alignment of the mould cavity portions can be obtained in real-time during the moulding process, thereby improving the accuracy of the moulded components without compromising the amount of time required for the moulding process.

According to a further aspect of the invention, a method of moulding a workpiece is provided. The method comprises the steps of:

providing a mould tool as defined by the first aspect of the invention;

introducing material to be moulded into the mould cavity portion of the first tool part or the second tool part;

moving one of the first tool part or the second tool part towards the other of the first tool part and the second tool part to enclose the material within a mould cavity defined by the first and second tool parts;

using the sensor to sense the relative position of the first and second mould cavity portions; and

using the controller to control the temperature control system to adjust the position of the first mould cavity portion relative to the second mould cavity based on the sensed position, thereby aligning the mould cavity between the first and second tool parts;

applying a moulding pressure to the first and second tool parts; and,

moulding a workpiece using the mould tool.

According to a second aspect of the present invention, there is provided a mould tool comprising:

a first mould tool part defining a first mould cavity portion;

a second mould tool part defining a second mould cavity portion; and

a mould tool alignment sensor that is configured to detect the position of the first mould

cavity portion relative to the second mould cavity portion, the mould tool alignment sensor including:

an emitter that is configured to emit a signal, said signal travelling along a signal path, the signal being influenced by the relative positions of the first mould tool part and the second mould tool part; and

a detector that is configured to detect the signal, the detected signal being indicative of the position of the first mould cavity portion relative to the second mould cavity portion.

Advantageously, the mould tool alignment sensor enables the position of one of the mould cavity portions relative to the other mould cavity portion to be measured and adjusted dynamically in order to ensure that the mould cavity portions, or profiles, are correctly aligned throughout the moulding cycle, including during closure, injection, holding and cooling. The mould tool alignment system is particularly advantageous as it enables the fine-tuning or adjustment of the mould cavity portions to be undertaken in real-time before and during the moulding process, thereby improving the accuracy of the moulded components without compromising the amount of time required for the moulding process.

The emitter may be an electromagnetic emitter, the detector may be an electromagnetic detector and the signal may be an electromagnetic signal.

The emitter may be an optical emitter, the detector may be an optical detector and the signal may be an optical signal.

The sensor may further comprise:

a signal path modifier that is associated with the first tool part or the second tool part,

wherein the signal path modifier is positioned in the signal path between the emitter and the detector to thereby produce a variable signal at the detector, the variable signal being dependent on the position of the first mould cavity portion relative to the second mould cavity portion.

The emitter may be associated with the first tool part and the detector may be associated with the second tool part.

In some embodiments of the invention, the sensor may include more than one signal path modifier.

The signal path modifier may, for example, be one of two signal path modifiers, such that the mould tool alignment sensor comprises:

a first signal path modifier that is associated with the first tool part, and

a second signal path modifier that is associated with the second tool part,

wherein the first and second signal path modifiers are positioned in the signal path between the emitter and the detector to thereby produce a variable signal at the detector, the variable signal being dependent on the position of the first mould cavity portion relative to the second mould cavity portion.

The first signal path modifier may provided on a first surface of the first tool part and/or the second signal path modifier may be provided on a second surface of the second tool part.

Alternatively, the first signal path modifier may be formed in a first surface of the first tool part and/or the second signal path modifier may be formed in a second surface of the second tool part.

One or both of the signal path modifiers may be a plurality of openings or other regions being at least partially transparent to the signal. One or both of the signal path modifiers may comprise a plurality of substantially signal-transparent regions. The plurality of substantially signal-transparent regions may be openings. One or both of the signal path modifiers may be grates. One or both of the signal path modifiers may be lenses.

In alternative embodiments of the invention, each of the emitter and the detector may be associated with the first tool part and the signal path modifier may be associated with the second tool part.

A further signal path modifier may be associated with the first tool part.

One or both of the signal path modifier and the further signal path modifier may be an interface which changes the direction of the signal. One or both of the signal path modifier and the further signal path modifier may be a reflector.

The signal may be reflected more than one, for example more than twice, so that the length of the signal path is increased. Advantageously, this enables the signal to be magnified.

The first tool part may further include an anchor point by which the first tool part is fastened to the mould tool. The anchor point and the sensor may be provided on opposing sides of the first mould cavity portion.

The mould tool may further comprise:

an actuator to effect movement of the first mould cavity portion relative to the second mould cavity portion in a direction normal to the mould closure direction; and

a controller configured to control the actuator in response to feedback from the sensor to thereby control the position of the first mould cavity portion relative to the second mould cavity portion.

The actuator may include a temperature control system configured to control the temperature of a first zone of the first tool part to thereby effect thermal expansion and/or contraction in the first zone of the first tool part.

The first zone of the first tool part may be spaced apart from the first mould cavity portion. In other words, the first zone does not overlap the first mould tool cavity portion when viewed from a mould closure direction. Advantageously, this means that expansion and contraction of the zone will primarily influence the position of the cavity, rather than the shape of the cavity.

At least one of the first and second tool parts may be moveable towards and away from the other of the first and second tool parts in a mould closure direction such that the first and second mould cavity portions cooperate to define a mould cavity for moulding a workpiece. The said thermal expansion and/or contraction in the first zone of the first tool part may be in a direction that is normal, i.e. perpendicular, to the mould closure direction.

The temperature control system may also be configured to independently control the temperature of a second zone of the first tool part to thereby effect thermal expansion and/or contraction in the second zone of the first tool part. The sensor may be configured to measure movement of a second part of the first tool part in response to the said thermal expansion and/or contraction in the second zone of the first tool part, wherein the said thermal expansion and/or contraction in the second zone of the first tool part is in a direction that is normal, i.e. perpendicular, to the mould closure direction.

The direction of the said thermal expansion and/or contraction in the second zone of the first tool part may be different to the direction of the said thermal expansion and / or contraction in the first zone of the first tool part.

The direction of the said thermal expansion and/or contraction in the second zone of the first tool part may be normal to the direction of the said thermal expansion and/or contraction in the first zone of the first tool part.

The second zone of the first tool part may be spaced apart from the first mould cavity portion. In other words, the second zone does not overlap the first mould tool cavity portion when viewed from a mould closure direction. Advantageously, this means that expansion and contraction of the zone will primarily influence the position of the cavity, rather than the shape of the cavity.

According to a third aspect of the present invention there is provided a mould tool comprising:

a first tool part defining a first mould cavity portion, the first tool part comprising a plurality of tessellated temperature control zones, wherein a first of the temperature control zones at least partially overlaps the first mould cavity portion, and wherein a second of the tessellated temperature control zones is spaced apart from the first mould cavity portion;

a second tool part defining a second mould cavity portion;

in which the first and second mould cavity portions cooperate to define a mould cavity for moulding a workpiece;

a temperature control system configured to independently control the temperature of each of the plurality of tessellated temperature control zones; and,

a cavity alignment system comprising:

a controller configured to control the temperature of the second zone to thereby effect thermal expansion and/or contraction in the second zone to thereby control the position of the first mould cavity portion relative to the second mould cavity portion.

By spaced apart we mean that the second tessellated temperature control zone does not overlap the first mould tool cavity portion when viewed from a mould closure direction. Advantageously, this means that expansion and contraction of the zone will primarily influence the position of the cavity, rather than the shape of the cavity.

Advantageously, the cavity alignment system enables changes in the position of one of the mould cavity portions relative to the other mould cavity portion to be measured and adjusted dynamically in order to ensure that the mould cavity portions, or profiles, are correctly aligned throughout the moulding cycle, including during closure, injection, holding and cooling. The cavity alignment system is particularly advantageous as it enables the fine-tuning or adjustment of the mould cavity portions to be undertaken in real-time before and during the moulding process, thereby improving the accuracy of the moulded components without compromising the amount of time required for the moulding process. The system advantageously employs a single controller and components that are also provided for optimisation of the moulding conditions, thereby reducing the complexity of an alignment system.

At least one of the first and second tool parts may be moveable towards and away from the other of the first and second tool parts in a mould closure direction. The said thermal expansion and/or contraction in the second zone of the first tool part may be in a direction that is normal, i.e. perpendicular, to the mould closure direction.

A third of the tessellated temperature control zones may be spaced apart from the first mould cavity portion. The controller may be further configured to control the temperature control system of the third zone to thereby effect thermal expansion and/or contraction in the third zone to thereby control the position of the first mould cavity portion relative to the second mould cavity portion. The said thermal expansion and/or contraction in the third zone of the first tool part may be in a direction that is normal, i.e. perpendicular, to the mould closure direction.

By spaced apart we mean that the third tessellated temperature control zone does not overlap the first mould tool cavity portion when viewed from a mould closure direction. Advantageously, this means that expansion and contraction of the zone will primarily influence the position of the cavity, rather than the shape of the cavity.

The direction of the said thermal expansion and/or contraction in the third zone of the first tool part may be different to the direction of the said thermal expansion and/or contraction in the second zone of the first tool part.

The direction of the said thermal expansion and/or contraction in the third zone of the first tool part may be normal, i.e. perpendicular, to the direction of the said thermal expansion and/or contraction in the second zone of the first tool part.

The first tool part may further include a sensor configured to measure movement of a part of the first tool part in response to the said thermal expansion and/or contraction in the first tool part.

The mould tool may further comprise an anchor point by which the first tool part is fastened to the mould tool, wherein the anchor point and the sensor are provided on opposing sides of the first mould cavity portion.

The sensor may comprise:

an emitter that is configured to emit a signal, said signal travelling along a signal path, the signal being influenced by the position of the first mould cavity portion relative to the second mould cavity portion; and

a detector that is configured to detect the signal, the detected signal being thereby indicative of the position of the first mould cavity portion relative to the second mould cavity portion.

The emitter may be an electromagnetic emitter, the detector may be an electromagnetic detector and the signal may be an electromagnetic signal.

The emitter may be an optical emitter, the detector may be an optical detector and the signal may be an optical signal.

The sensor may further comprise:

a signal path modifier that is associated with the first tool part or the second tool part,

wherein the signal path modifier is positioned in the signal path between the emitter and the detector to thereby produce a variable signal at the detector, the variable signal being dependent on the position of the first mould cavity portion relative to the second mould cavity portion.

The emitter may be associated with the first tool part and the detector may be associated with the second tool part.

In some embodiments of the invention, the sensor may include more than one signal path modifier.

The signal path modifier may, for example, be one of two signal path modifiers such that the mould tool alignment sensor comprises:

a first signal path modifier that is associated with the first tool part, and

a second signal path modifier that is associated with the second tool part,

wherein the first and second signal path modifiers are positioned in the signal path between the emitter and the detector to thereby produce a variable signal at the detector, the variable signal being dependent on the position of the first mould cavity portion relative to the second mould cavity portion.

The first signal path modifier may be provided on a first surface of the first tool part and/or the second signal path modifier may be provided on a second surface of the second tool part.

The first signal path modifier may be formed in a first surface of the first tool part and/or the second signal path modifier may be formed in a second surface of the second tool part.

One or both of the signal path modifiers may be a plurality of openings or other regions being at least partially transparent to the signal. One or both of the signal path modifiers may comprise a plurality of substantially signal-transparent regions. The plurality of substantially signal-transparent regions may be openings. One or both of the signal path modifiers may be grates. One or both of the signal path modifiers may be lenses.

In alternative embodiments of the invention, each of the emitter and the detector may be associated with the first tool part and the signal path modifier may be associated with the second tool part.

A further signal path modifier may be associated with the first tool part.

One or both of the signal path modifier and the further signal path modifier may be an interface which changes the direction of the signal. One or both of the signal path modifier and the further signal path modifier may be a reflector.

The signal may be reflected more than one, for example more than twice, so that the length of the signal path is increased. Advantageously, this enables the signal to be magnified.

According to an aspect of the present invention there is also provided a method of aligning a mould tool the method including the steps of:

providing a mould tool as defined by the third aspect of the present invention;

using the controller to control the temperature of the second zone to thereby effect thermal expansion and/or contraction in the second zone in order to control the position of the first mould cavity portion relative to the second mould cavity portion.

The method may further include the steps of:

moving one of the first tool part and the second tool part towards the other of the first tool part and the second tool part such that the first tool part and the second part are in abutting contact;

using the controller to control the temperature of the second zone to thereby effect thermal expansion and/or contraction in the second zone to thereby control the position of the first mould cavity portion relative to the second mould cavity portion in order to define an aligned mould cavity between the first and second tool parts.

When the first and second tool parts define the aligned mould cavity, a moulding pressure may be applied to the first tool part and the second tool part.

According to another aspect of the present invention there is provided a method of moulding a workpiece, the method comprising the steps of:

providing a mould tool as defined by the third aspect of the invention;

introducing material to be moulded into the mould cavity portion of the first tool part or the second tool part;

moving one of the first tool part or the second tool part towards the other of the first tool part and the second tool part to enclose the material within a mould cavity defined by the first and second tool parts;

using the temperature control system to independently control the temperature of each of the plurality of tessellated temperature control zones; and,

using the controller to control the temperature of the second zone to thereby effect thermal expansion and/or contraction in the second zone in order to control the position of the first mould cavity portion relative to the second mould cavity portion.

According to a fourth aspect of the present invention there is provided a mould tool comprising:

a first tool part defining a first mould cavity portion;

a second tool part defining a second mould cavity portion;

in which at least one of the first and second tool parts is moveable towards and away from the other of the first and second tool parts in a mould closure direction such that the first and second mould cavity portions cooperate to define a mould cavity for moulding a workpiece; and,

a cavity alignment system comprising:

an actuator to effect movement of the first mould cavity portion relative to the second mould cavity portion in a direction normal to the mould closure direction;

a sensor configured to measure movement of a part of the first tool part relative to the second tool part in response to movement effected by the actuator, the sensor comprising an optical emitter and an optical detector; and,

a controller configured to control the actuator in response to feedback from the sensor to thereby control the position of the first mould cavity portion relative to the second mould cavity portion.

Advantageously, the cavity alignment system enables the position of one of the mould cavity portions relative to the other mould cavity portion to be measured and adjusted dynamically in order to ensure that the mould cavity portions, or profiles, are correctly aligned throughout the moulding cycle, including during closure, injection, holding and cooling. The cavity alignment system is particularly advantageous as it enables the fine-tuning or adjustment of the mould cavity portions to be undertaken in real-time during the moulding process, thereby improving the accuracy of the moulded components without compromising the amount of time required for the moulding process.

The sensor may also comprise:

a signal path modifier that is associated with the first tool part or the second tool part,

wherein the signal path modifier is positioned in the signal path between the optical emitter and the optical detector to thereby produce a variable signal at the optical detector, the variable signal being dependent on the position of the first mould cavity portion relative to the second mould cavity portion.

The optical emitter may be associated with the first tool part and the optical detector may be associated with the second tool part.

In some embodiments of the invention, the sensor may include more than one signal path modifier.

The signal path modifier may, for example, be one of two signal path modifiers, such that the mould tool alignment sensor comprises:

a first signal path modifier that is associated with the first tool part, and

a second signal path modifier that is associated with the second tool part,

wherein the first and second signal path modifiers are positioned in the signal path between the optical emitter and the optical detector to thereby produce a variable signal at the detector, the variable signal being dependent on the position of the first mould cavity portion relative to the second mould cavity portion.

The first signal path modifier may be provided on a first surface of the first tool part and/or the second signal path modifier may be provided on a second surface of the second tool part.

Alternatively, the first signal path modifier may be formed in a first surface of the first tool part and/or the second signal path modifier may be formed in a second surface of the second tool part.

One or both of the signal path modifiers may be a plurality of openings or other regions being at least partially transparent to the signal. One or both of the signal path modifiers may comprise a plurality of substantially signal-transparent regions. The plurality of substantially signal-transparent regions may be openings. One or both of the signal path modifiers may be grates. One or both of the signal path modifiers may be lenses.

In alternative embodiments of the invention, each of the emitter and the detector may be associated with the first tool part and the signal path modifier may be associated with the second tool part.

A further signal path modifier may be associated with the first tool part.

One or both of the signal path modifier and the further signal path modifier may be an interface which changes the direction of the signal. One or both of the signal path modifier and the further signal path modifier may be a reflector.

The signal may be reflected more than one, for example more than twice, so that the length of the signal path is increased. Advantageously, this enables the signal to be magnified.

The first tool part may further include an anchor point by which the first tool part is fastened to the mould tool. The anchor point and the sensor may be provided on opposing sides of the mould tool.

The actuator may include a temperature control system configured to control the temperature of a first zone of the first tool part to thereby effect thermal expansion and/or contraction in the first zone of the first tool part.

The first zone of the first tool part may be spaced apart from the first mould cavity portion. In other words, the first zone does not overlap the first mould tool cavity portion when viewed from a mould closure direction. Advantageously, this means that expansion and contraction of the zone will primarily influence the position of the cavity, rather than the shape of the cavity.

At least one of the first and second tool parts may be moveable towards and away from the other of the first and second tool parts in a mould closure direction such that the first and second mould cavity portions cooperate to define a mould cavity for moulding a workpiece. The said thermal expansion and/or contraction in the first zone of the first tool part may be in a direction that is normal, i.e. perpendicular, to the mould closure direction.

The temperature control system may also be configured to independently control the temperature of a second zone of the first tool part to thereby effect thermal expansion and/or contraction in the second zone of the first tool part. The said thermal expansion and/or contraction in the second zone of the first tool part may be in a direction that is normal, i.e. perpendicular, to the mould closure direction.

The direction of the said thermal expansion and/or contraction in the second zone of the first tool part may be different to the direction of the said thermal expansion and/or contraction in the first zone of the first tool part.

The direction of the said thermal expansion and/or contraction in the second zone of the first tool part may be normal, i.e. perpendicular, to the direction of the said thermal expansion and/or contraction in the first zone of the first tool part.

The second zone of the first tool part may be spaced apart from the first mould cavity portion. In other words, the second zone does not overlap the first mould tool cavity portion when viewed from a mould closure direction. Advantageously, this means that expansion and contraction of the zone will primarily influence the position of the cavity, rather than the shape of the cavity.

According to a yet further aspect of the present invention there is provided a method of aligning a mould tool the method including the steps of:

providing a mould tool as defined by the fourth aspect of the invention; and

using the controller to control the actuator in response to feedback from the sensor to thereby control the position of the first mould cavity portion relative to the second mould cavity portion.

The method may further include the steps of:

moving one of the first tool part and the second tool part towards the other of the first tool part and the second tool part such that the first tool part and the second part are in abutting contact;

using the controller to control the actuator in response to feedback from the sensor to thereby

effect movement of the first mould cavity portion relative to the second mould cavity portion in a direction normal to the mould closure direction such that the first mould cavity portion and the second mould cavity portion are aligned.

When the first mould cavity portion and the second mould cavity portion are aligned, a moulding pressure may be applied to the first tool part and the second tool part.

According to another aspect of the invention there is provided a method of moulding a workpiece, the method comprising the steps of:

providing a mould tool as defined by the fourth aspect of the invention;

introducing material to be moulded into the mould cavity portion of the first tool part or the second tool part;

moving one of the first tool part or the second tool part towards the other of the first tool part and the second tool part to enclose the material within a mould cavity defined by the first and second tool parts; and

using the controller to control the actuator in response to feedback from the sensor to thereby

effect movement of the first mould cavity portion relative to the second mould cavity portion in a direction normal to the mould closure direction such that the first mould cavity portion and the second mould cavity portion are aligned.

According to a fifth aspect of the present invention there is provided a mould tool alignment sensor comprising:

an optical emitter;

an optical detector;

a first signal path modifier for attachment to a first mould tool; and,

a second signal path modifier for attachment to a second mould tool;

in which the first and second signal path modifiers are positioned in a light path between the optical emitter and the optical detector to thereby produce a variable light signal at the optical detector, wherein the variable light signal is dependent on the relative positions of the first and second signal path modifiers; and

a controller configured to determine the relative position of the first and second signal path modifiers based on the variable light signal detected by the optical detector.

One or both of the first and/or second signal path modifiers may comprise a plurality of substantially signal-transparent regions. The plurality of substantially signal-transparent regions may be openings. The first and/or second signal path modifiers may be grates.

According to a sixth aspect of the invention there is provided a mould tool comprising:

a first tool part defining a first mould cavity portion and a temperature control surface on a face opposite to the first mould cavity portion, the first tool part comprising a reflective signal modifier on the temperature control surface;

a temperature control system configured to heat and/or cool the temperature control surface of the first tool part;

a controller configured to control the temperature control system; and,

a sensor comprising:

a signal emitter configured to direct a signal at the reflective signal modifier to produce a reflected modified signal, the reflected modified signal being dependent on a change in position of the temperature control surface; and,

a signal sensor configured to sense the reflected modified signal and produce a data output representative of the change in position of the temperature control surface;

wherein the controller is configured to control the temperature control system in response to the data output form the signal sensor to counter the change in position of the temperature control surface.

Preferably there is provided:

a second tool part defining a second mould cavity portion;

the first and second mould cavity portions together defining a mould cavity for moulding a workpiece;

the first and/or second mould tool parts being moveable in a mould closure direction to close the mould tool;

wherein the reflected modified signal is dependent on the change in position of the temperature control surface in the mould closure direction; and,

the signal sensor is configured to sense the reflected modified signal and produce the data output representative of the change in position of the temperature control surface in the mould closure direction.

Preferably the first tool part comprises a plurality of tessellated, individually temperature controlled zones, in which at least one of the zones comprises the signal modifier.

Preferably the at least one of the zones comprises a geometric centre and a perimeter, and wherein the signal modifier is positioned closed to the geometric centre than the periphery.

Preferably the signal modifier is positioned at the geometric centre.

Preferably:

each of the plurality of zones comprises:

a respective reflective signal modifier;

a respective a temperature control system;

a respective sensor;

wherein the controller is configured to control each respective temperature control system in response to the data output form each respective signal sensor to at least partially counteract the change in position of the temperature control surface at each respective reflective signal modifier.

Preferably the sensor is configured such that the signal is reflected from the reflective signal modifier a plurality of times before being sensed by the signal sensor.

Preferably the emitter is an electromagnetic emitter, the detector is an electromagnetic detector and the signal is an electromagnetic signal.

Preferably the emitter is an optical emitter, the detector is an optical detector and the signal is an optical signal.

A mould tool and associated method will now be described in accordance with the present invention and with reference to the following figures, in which:

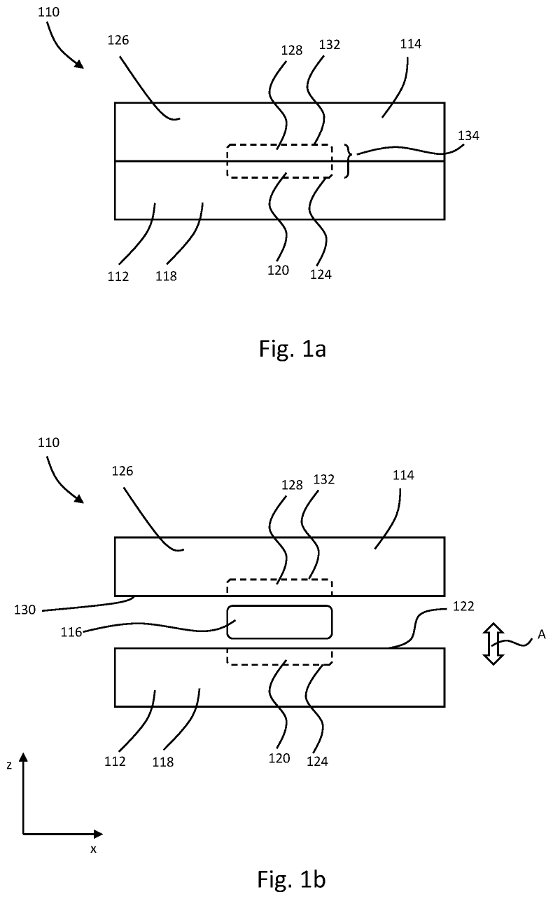

FIG. 1a is a schematic side section view of a mould tool in accordance with the present invention in a closed position;

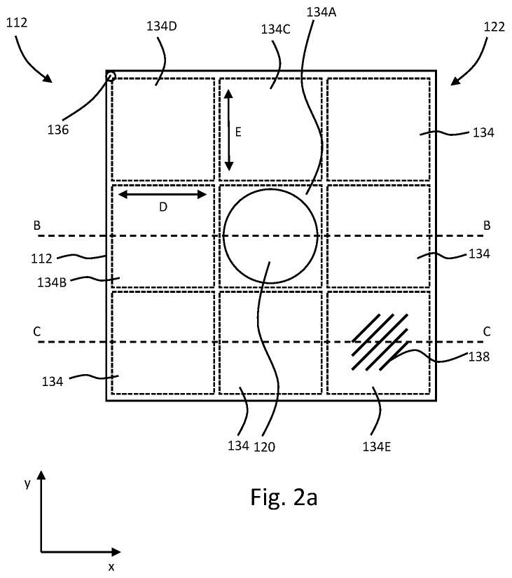

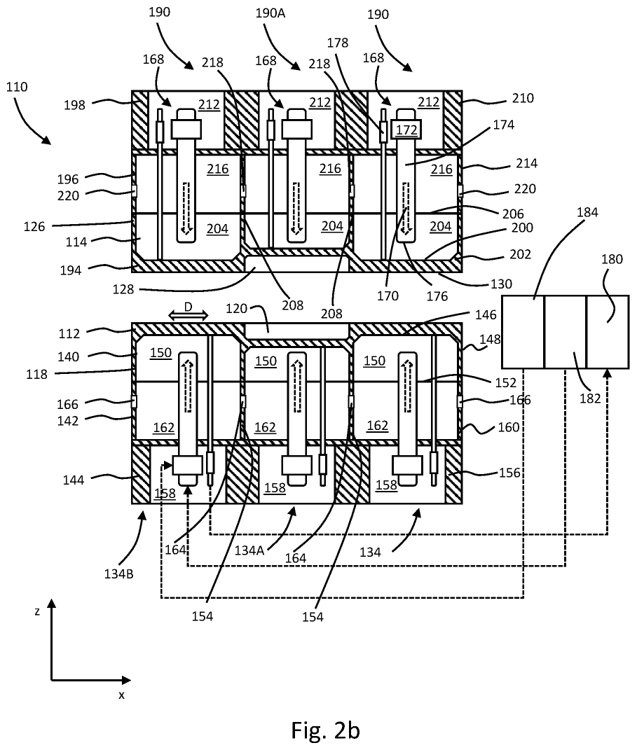

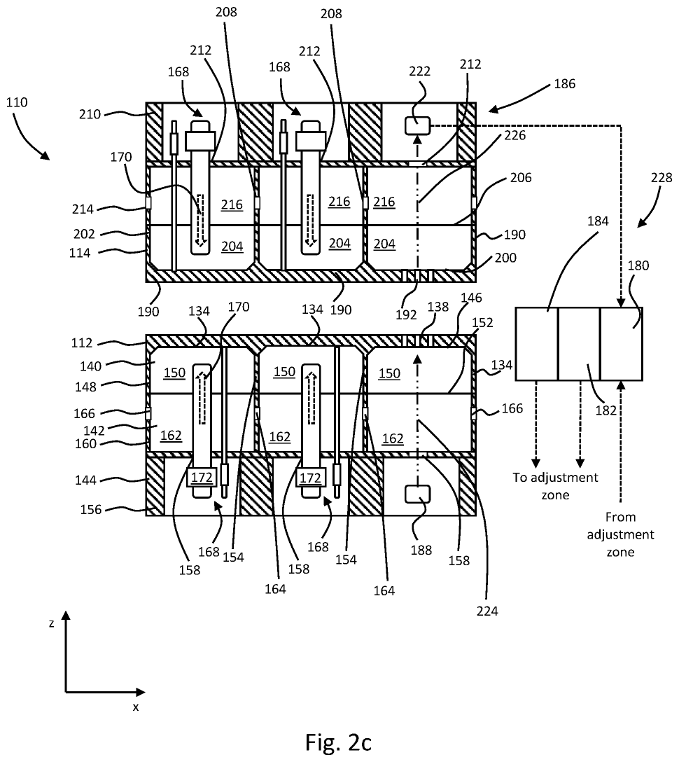

FIG. 1b is a schematic side section view of the mould tool of FIG. 2a in an open position;

FIG. 2a is a top view of a first mould tool part of the mould tool of FIG. 1b;

FIG. 2b is a section view of the mould tool of FIG. 2a through line B-B;

FIG. 2c is a section view of the mould tool of FIG. 2a through line C-C;

FIG. 3 is a flow chart for a method of moulding using a mould tool according to the present invention;

FIG. 4a is a schematic representation of a first signal path modifier for use with the mould tool of FIG. 1 a;

FIG. 4b is a schematic representation of a second signal path modifier for use with the mould tool of FIG. 1a;

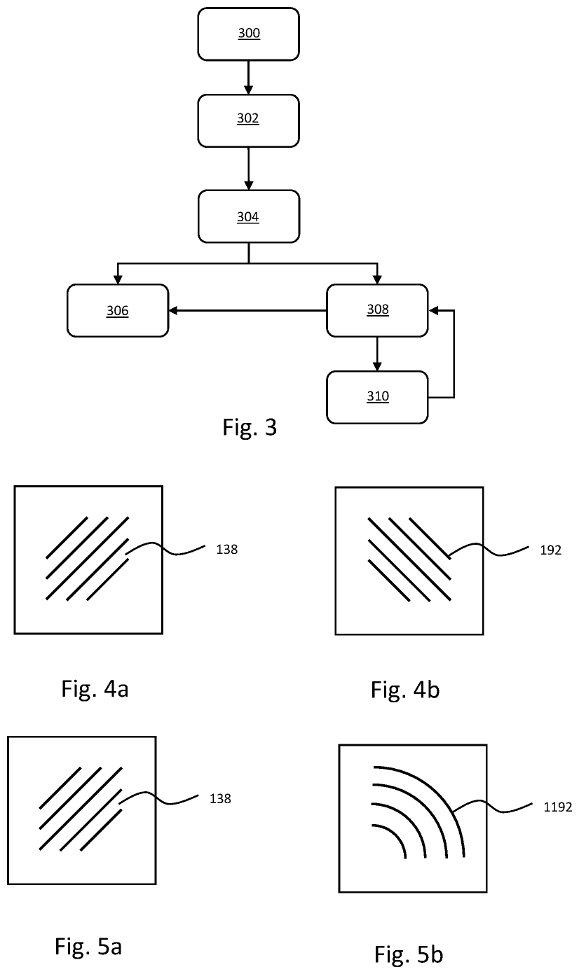

FIG. 5a is a schematic representation of the first signal path modifier of FIG. 4a;

FIG. 5b is a schematic representation of an alternative second signal path modifier for use with the mould tool of FIG. 1a;

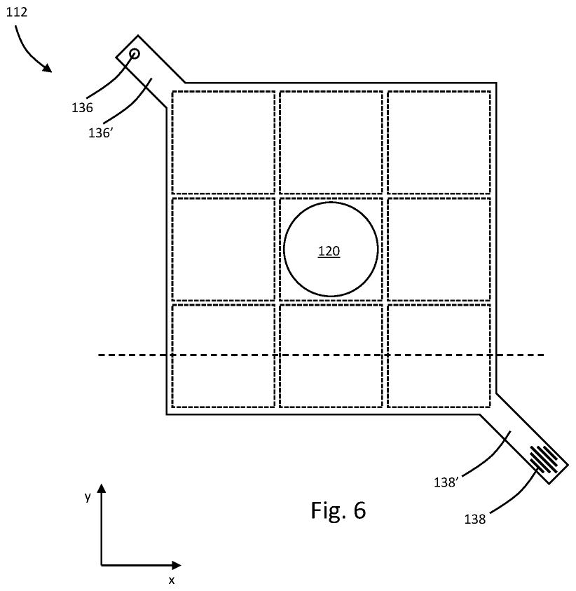

FIG. 6 is a top view of an alternative mould tool part for use with the mould tool of FIG. 1b;

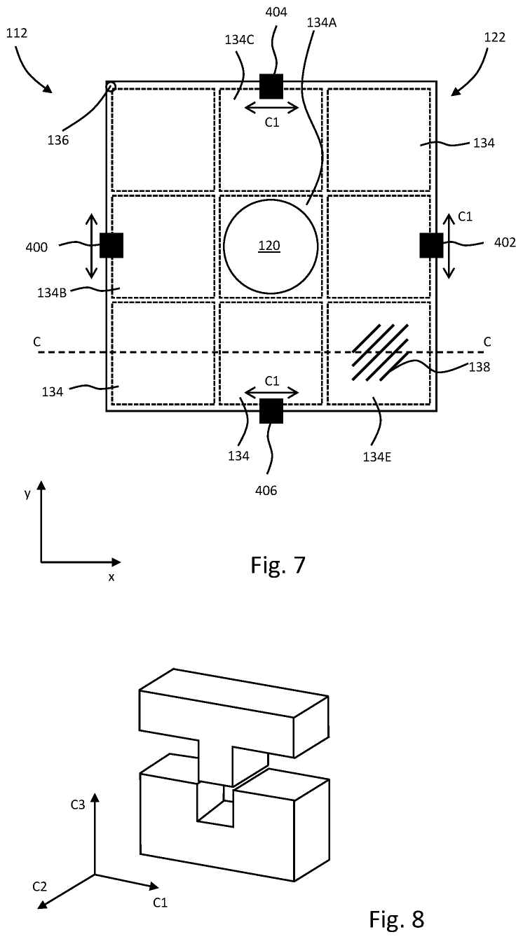

FIG. 7 is a top view of a further alternative mould tool part for use with the mould tool of FIG. 1b;

FIG. 8 is a perspective view of a top lock for use with the mould tool of FIG. 1b;

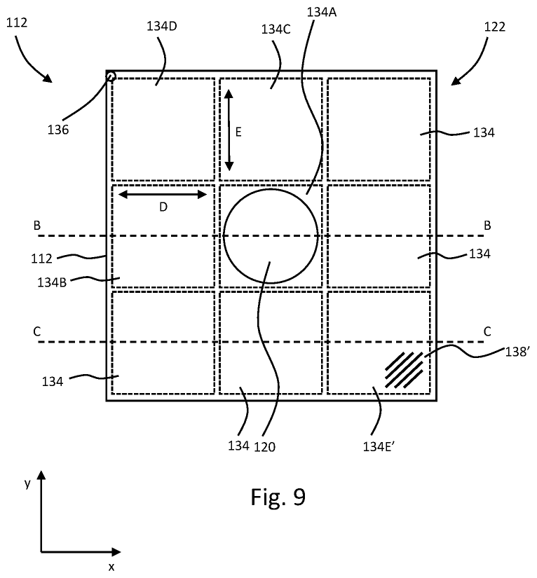

FIG. 9 is top view of an alternative first mould tool part of the mould tool of FIG. 1b;

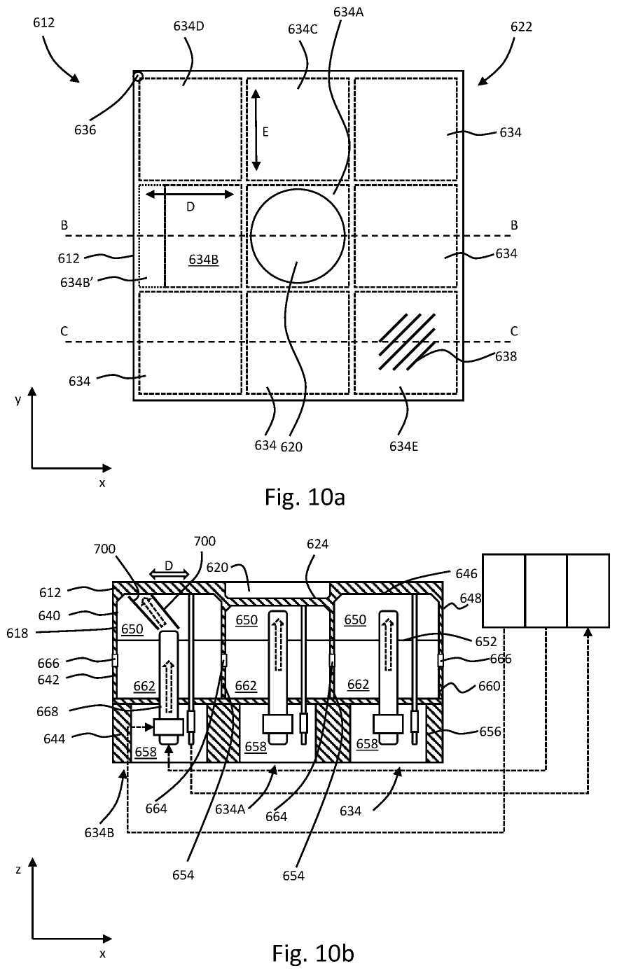

FIG. 10a is a top view of a further alternative first mould tool part of the mould tool of FIG. 1b;

FIG. 10b is a is a section view of the mould tool of FIG. 10a through line B-B;

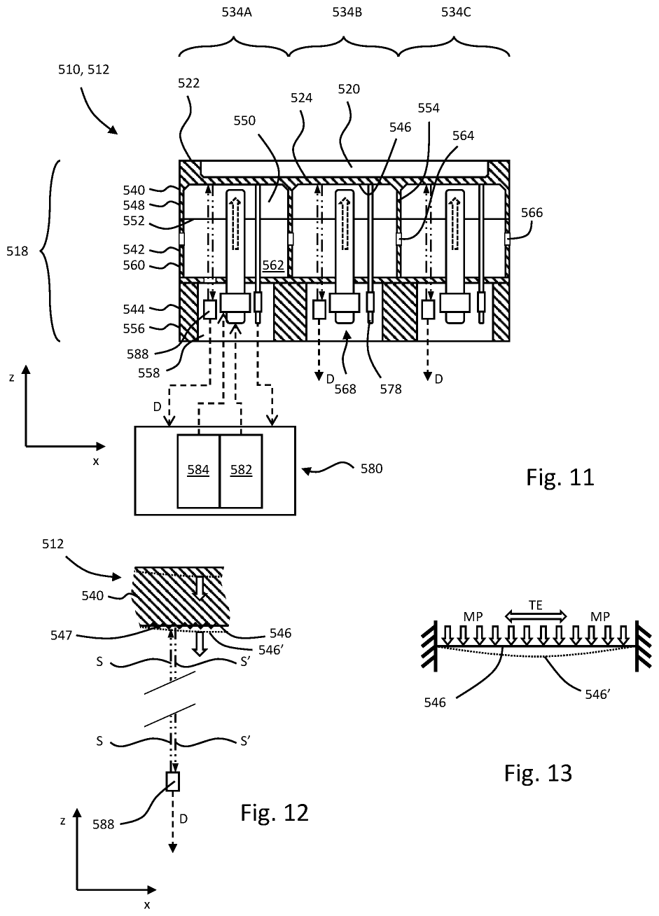

FIG. 11 is a schematic side section view of a mould tool in accordance with the present invention;

FIG. 12 is a detail view of a part of the mould tool of FIG. 11;

FIG. 13 is a schematic diagram of a mould tool zone under the influence of heat and pressure;

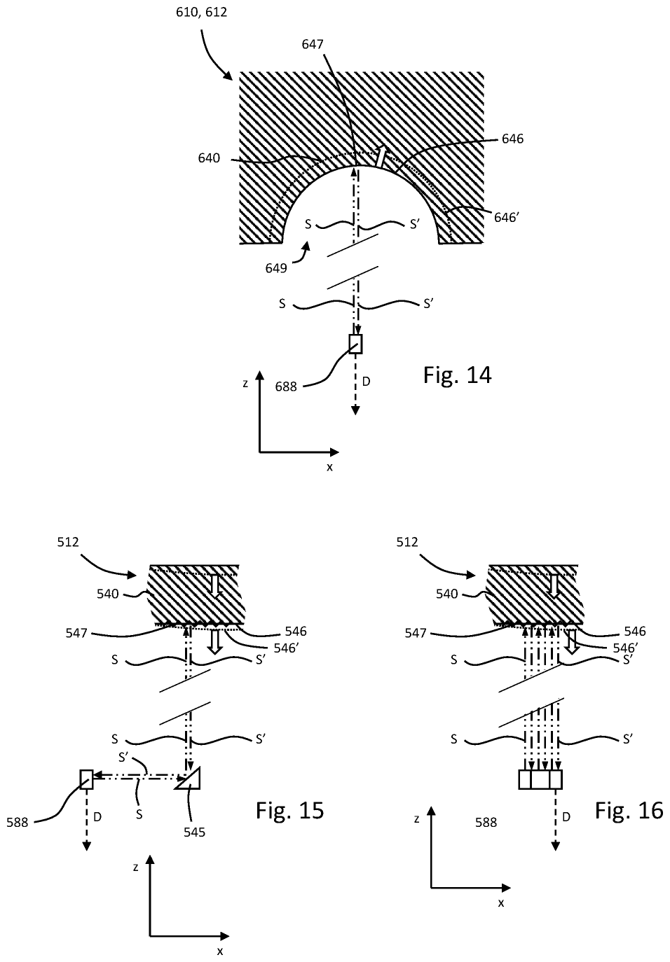

FIG. 14 is a detail section view of a part of a first alternative mould tool;

FIG. 15 is a detail section view of a part of a second alternative mould tool;

FIG. 16 is a detail section view of a part of a third alternative mould tool.

Referring to FIGS. 1a and lb, an example of a mould tool 110 according to the present invention is shown. The mould tool 110 has a first tool part 112 and a second tool part 114. A workpiece 116 formed by the mould tool 110 is also shown.

The first tool part 112 of the mould tool 110 is a lower part and has a body 118 that is constructed from a metal material and has a mould cavity portion 120 defined on its upper surface 122. The profile 124 of the mould cavity portion 120 defines part of the outer surface of the workpiece 116.

Turning now to FIG. 2a, the upper surface 122 of the first tool part 112 is shown. The upper surface 122 is divided into a plurality of adjacent or tessellated tool zones 134.

One of the tessellated tool zones, the mould cavity control zone 134A is associated with the mould cavity portion 120 such that the mould cavity control zone 134A overlaps the mould cavity portion 120.

The upper surface 122 of the first tool part 112 also includes an anchor or fixing point 136 and a signal path modifier in the form of a grate 138. Each of the anchor point 136 and the grate 138 are associated with separate tool zones 134D, 134E, respectively. The tool zones 134D, 134E are spaced apart from the mould cavity portion 120 such that no part of the tool zones 134D or 134E overlaps any part of the mould cavity portion 120. The tool zone 134D is also spaced apart from the tool zone 134E.

Two of the tessellated tool zones 134B, 134C are positioned between the mould cavity portion 120 and the anchor point 136 and are actuator or adjustment zones. The actuator zone 134B is positioned laterally relative to the mould cavity control zone 134A and longitudinally relative to the anchor point 136. The actuator zone 134C is positioned longitudinally relative to the mould cavity control zone 134A and laterally relative to the anchor point 136. Neither of the actuator zones 134B, 134C overlaps any part of the mould cavity portion 120.

The grate 138 is a structure having a regular or periodic pattern of varying thickness. The grate 138 may, for example, be a structure in which a regular pattern of apertures or slits is provided to split or diffract a wave signal. In some embodiments of the present invention, the grate 138 may be a diffraction grating or other optical component having a periodic structure that splits and diffracts light.

With reference to FIGS. 2b and 2c, the body 118 of the first tool part 112 comprises a first, mould, layer 140, an intermediate, exhaust, layer 142 and a second, utilities, layer 144.

The first layer 140 includes the upper surface 122 of the first tool part 112. On the underside of the upper surface 122, a temperature control surface 146 is defined as will be described below.

The first layer 140 is surrounded by a peripheral wall 148 so as to define an enclosed volume. The first layer 140 defines a number of discrete chambers 150 which are bound by a part of the temperature control surface 146 at a first end and open at a second end 152. The chambers 150 are separated by chamber walls 154 which extend from the temperature control surface 146 to the open ends 152. As such, the first layer 140 defines a type of honeycomb structure comprising a number of discrete cell-like chambers 150. Each of the chambers 150 corresponds to a tool zone 134.

The second layer 144 includes a block 156 having a number of through bores 158 defined therein. Each of the through bores 158 contains mounting apparatus for an inline temperature control assembly 168 (as will be described below).

The intermediate layer 142 is intermediate the first and second layers 140, 144 and includes a block 160 having a number of through bores 162 defined therein. The through bores 162 are in fluid communication via internal ports 164. The through bores proximate the periphery of the block 160 are in fluid communication with the exterior of the tool via exhaust ports 166. As such, the intermediate layer 142 provides an exhaust functionality as will be described below.

A number of the tool zones 134 have an associated temperature control system or assembly 168 which is arranged to provide a fluid flow 170 to and from the tool zone 134 in order to alternately heat and cool the tool zone 134. In this example, the temperature control system 168 has a heater assembly 172, an elongate tube section 174, an outlet 176 and a thermocouple 178. In this embodiment, the thermocouple 178 is an ultra precise thermocouple. In other examples of the invention, a resistance temperature detector (RTD) may be provided. Each of the heater assemblies 172 is mounted within the second layer 144 within a through bore 158 and extends upwardly from the second layer 144 towards the temperature control surface 146. Similarly, each thermocouple 178 is spring-loaded upwardly from the second layer 144 towards the temperature control surface 146. Each of the temperature control systems 168 is connected to a controller 180. The controller 180 includes air valves 182, by which the rate of flow of air through the temperature control systems 168 can be controlled, and heater switches 184, by which the temperature of the air within the temperature control systems 168 can be controlled.

In the prior art systems of the present applicant, the air valves 182 are bi-stable. In other words, a first flow rate is provided for heating (with the heater 172 activated) and a second, higher, flow rate is provided for cooling (with the heater 172 deactivated). In order to provide a finer degree of control for smaller temperature variations (as required with sub-micron adjustments to cavity positions), a fully variable air valve 182 is provided that can adjust the flow to the desired rate. The heater 172 is controlled by supplying power according to a mark-space ratio, and as such is also highly variable (only limited by the frequency of the power input signal). Therefore, fine adjustment to heating is provided to the actuator zones 134B, 134C (and also optionally to the remaining zones).

The tool zone 134E includes an emitter 188, for example an optical emitter or light source such as a laser comprising a plurality of laser diodes, and the grate 138, which includes a regular pattern of apertures. As shown in FIG. 2c, the emitter 188 is positioned within the second, utilities, layer 144 and the grate 138 is provided on the upper surface 122 of the first, mould, layer 140. The emitter 188 and grate 138 form part of a mould tool alignment or position detection sensor 186, as will be described below.

Opposite the first tool part 112, the second part 114 has a body 126 that is also constructed from a metal material and has a mould cavity portion 128 defined on its surface 130. The profile 132 of the mould cavity portion 128 defines part of the outer surface of the workpiece 116.

Like the upper surface 122 of the first tool part 112, the surface 130 of the second tool part 114 is divided into a plurality of adjacent or tessellated tool zones 190.

One of the tessellated tool zones, the mould cavity control zone 190A is associated with the mould cavity portion 128 such that the mould cavity control zone 190A overlaps the mould cavity portion 128.

The surface 130 of the second tool part 114 also includes an anchor or fixing point (not shown) and a signal path modifier in the form of a grate 192. Each of the anchor point and the grate 192 are associated with separate tool zones 190. The tool zone (not shown) that is associated with the anchor point (not shown) and the tool zone 190E that is associated with the grate 192 are both spaced apart from the mould cavity portion 128 such that no part of those tool zones overlaps any part of the mould cavity portion 128. The tool zone (not shown) that is associated with the anchor point (not shown) is also spaced apart from the tool zone 190E that is associated with the grate 192.

Like the grate 138 of the first tool part 112, the grate 192 of the second tool part 114 is a structure having a regular or periodic pattern of varying thickness. The grate 192 may, for example, be a structure in which a regular pattern of apertures or slits is provided to split or diffract a wave signal. In some embodiments of the present invention, the grate 192 may be a diffraction grating or other optical component having a periodic structure that splits and diffracts light.

Referring to FIGS. 2b and 2c, the body 126 of the second tool part 114 comprises a first, mould, layer 194, an intermediate, exhaust, layer 196 and a second, utilities, layer 198.

The first layer 194 includes the surface 130 of the second tool part 114. On the opposite side of the surface 130, a temperature control surface 200 is defined as will be described below.

The first layer 194 is surrounded by a peripheral wall 202 so as to define an enclosed volume. The first layer 194 defines a number of discrete chambers 204 which are bound by a part of the temperature control surface 200 at a first end and open at a second end 206. The chambers 204 are separated by chamber walls 208 which extend from the temperature control surface 200 to the open ends 206. As such, the first layer 194 defines a type of honeycomb structure comprising a number of discrete cell-like chambers 204. Each of the chambers 204 corresponds to a tool zone 190.

The second layer 198 includes a block 210 having a number of through bores 212 defined therein. Each of the through bores 212 contains mounting apparatus for an temperature control assembly 168 (as will be described below).

The intermediate layer 196 is intermediate the first and second layers 194, 198 and includes a block 214 having a number of through bores 216 defined therein. The through bores 216 are in fluid communication via internal ports 218. The through bores proximate the periphery of the block 214 are in fluid communication with the exterior of the tool via exhaust ports 220. As such, the intermediate layer 196 provides an exhaust functionality as will be described below.

As described in relation to the first tool part, a number of the tool zones 190 have an associated temperature control system or assembly 168, which is arranged to provide a fluid flow 170 to and from the tool zone 190 in order to alternately heat and cool the tool zone 190. Each of the heater assemblies 172 of the second tool part 114 is mounted within the second layer 198 within a through bore 212 and extends from the second layer 198 towards the temperature control surface 200. Similarly, each thermocouple 178 is spring-loaded from the second layer 198 towards the temperature control surface 200. Each of the temperature control systems 168 is connected to the controller 180.

The tool zone 190E includes a detector 222, for example an optical detector such as a light sensor chip, and the grate 192, which includes a regular pattern of apertures. As shown in FIG. 2c, the detector 222 is positioned within the second, utilities, layer 198 and the grate 192 is provided on the surface 130 of the first, mould, layer 194. The detector 222 and the grate 192 form part of the mould tool alignment or position detection sensor 186, as will be described below.

Components of the temperature control system 168, the controller 180 and the mould tool alignment or position detection sensor 186 cooperate as a cavity alignment system 228 for the mould tool 110.

The first tool part 112 is assembled as follows.

The heater assemblies 172 and the thermocouples 178 are mounted within the second layer 144 of the first tool part 112 within the through bores 158. It will be noted that a plurality of such heaters and thermocouples are installed into each of the through bores 158. The emitter 188 in the form of a laser is positioned within the second layer 144. A gasket (not shown) is placed on top of the second layer 144. The gasket includes a plurality of openings which form a tight seal around the tube section 174 of the heater 172. The bores 158 in which heaters 172 are installed are thus sealed once the heaters 172 are installed in the second layer 144 of the first tool part 112. A further opening is provided in the gasket such that a signal, in the form of light, from the laser 188 can be emitted out of the second layer 144 of the first tool part through the bore 158 of the block 156 in which the emitter 188 is installed, as described below.

The intermediate layer 142 is then placed on top of the second layer 144 such that each of the through bores 162 of the intermediate layer 142 is aligned with a respective through bore 158 in the second layer 144. Each of the through bores 162 that is aligned with a through bore 158 in which a heater 172 is installed has part of an air heater tube section 174 contained therein. The bore 162 that is aligned with the through bore 158 of the block 156 in which the emitter 188 is installed provides part of a signal or light path 224 along which light from the laser emitter 188 travels. A further gasket (not shown) is placed on top of the intermediate layer 142. The further gasket includes a plurality of openings which are substantially wider than the tube sections 174 of the heaters such that the through bores 162 are upwardly open.

The grate 138 is installed on the upper surface 122 of the first layer 140 such that the chamber 150 of tool zone 134E is upwardly open through the apertures in the grate 138. It will be understood that, in some embodiments of the invention, the grate 138 may be formed in the upper surface 122 of the first layer 140 during manufacture of the components of the mould tool 110. In other words, the grate 138 may be a separate component that is installed on the surface of the mould tool 110 or it may be an integral part of the mould tool 110 that is formed on the surface 122 of the first tool part 112 during manufacture.

Finally, the first layer 140 is stacked onto the intermediate layer 142 such that each of the chambers 150 is aligned with a respective through bore 162. As such, the through bores 162 and the chambers 150 are each in fluid communication with each other. The chamber 150 of tool zone 134E, on which the grate 138 is provided, is aligned with the bore 162 that is aligned with the through bore 158 of the block 156 in which the emitter 188 is installed and thus forms a further part of a signal or light path 224 along which light from the laser emitter 188 travels through the first tool part 112.

As shown in FIGS. 2b and 2c, when the first tool part 112 is assembled, the outlet 176 of the tube section 174 of the heater 172 ejects proximate the temperature control surface 146 of the first layer 140.

Each of the gaskets (not shown) is constructed from a thermally insulating material. The material has a thermal conductivity that is lower than the thermal conductivity of the material used to construct the layers 140, 142. As such, conduction between the first layer 140 and the intermediate layer 142 is minimised. Similarly, conduction between the intermediate layer 142 and the second layer 144 is minimised due to the gasket. In addition, the orifices in the gasket between the intermediate layer 142 and the second layer 144 form a tight seal around the tube sections 174 of the heaters 172. Therefore, with the exception of tool zone 134E in which no temperature control assembly 168 is installed, no passage of fluid between the through bore 158 and through bores 162 is permitted. As such, heat transfer by way of conduction and convection is not permitted between the intermediate layer 142 and the second layer 144.

In addition to the inline air heaters 172 extending from the second layer 144 through the intermediate layer 142 to the first layer 140, a series of thermocouples 178 having elongate bodies are spring-loaded upwardly from the second layer 144 towards the temperature control surface 146 to accurately measure the temperature of the first layer 140.

As also shown in FIG. 2c, when the first tool part 112 is assembled, the signal or light path 224 extends from the emitter 188, through the bore 158 of the second layer 144, through the bore 162 of the intermediate layer 142, through the chamber 150 of the first layer 140 and towards the apertures in the grate 138.

The second tool part 114 is assembled in a similar way.

The heater assemblies 172 and the thermocouples 178 are mounted within the second layer 198 of the second tool part 114 within the through bores 212. It will be noted that a plurality of such heaters and thermocouples are installed into each of the through bores 212.

The detector 222 in the form of a light sensor chip is positioned within the second layer 198 of the tool zone 190E. A gasket (not shown) is placed on top of the second layer 198. The gasket includes a plurality of openings which form a tight seal around the tube section 174 of the heater 172. The bores 212 in which heaters 172 are installed are thus sealed once the heaters 172 are installed in the second layer 198 of the second travel through the second layer 198 of the second tool part 114 through the bore 212 of the block 210 in which the detector 222 is installed, as described below.

The intermediate layer 196 is then placed on top of the second layer 198 such that each of the through bores 216 of the intermediate layer 196 is aligned with a respective through bore 212 in the second layer 198. Each of the through bores 216 that is aligned with a through bore 212 in which a heater 172 is installed has part of an air heater tube section 174 contained therein. The bore 216 that is aligned with the through bore 212 of the block 210 of tool zone 190E in which the detector 222 is installed provides part of a signal or light path 226 along which a signal, such as light, can travel towards the detector 222. A further gasket (not shown) is placed on top of the intermediate layer 196. The further gasket includes a plurality of openings which are substantially wider than the tube sections 174 of the heaters such that the through bores 216 are upwardly open.

The grate 192 is installed on the surface 130 of the first layer 194 such that the chamber 204 of tool zone 190E is open through the apertures in the grate 192. It will be understood that, in some embodiments of the invention, the grate 192 may be formed in the surface 130 of the first layer 194 during manufacture of the components of the mould tool 110. In other words, the grate 192 may be a separate component that is installed on the surface of the mould tool 110 or it may be an integral part of the mould tool 110 that is formed on the surface 130 of the second tool part 114 during manufacture.

Finally, the first layer 194 is stacked onto the intermediate layer 196 such that each of the chambers 204 is aligned with a respective through bore 216. As such, the through bores 216 and the chambers 204 are each in fluid communication with each other. The chamber 204 of tool zone 190E in which the grate 192 is provided is aligned with the bore 216. The bore 216 is aligned with the through bore 212 of the block 210 in which the detector 222 is installed and thus forms a further part of a signal or light path 226 through the second tool part 114.

As shown in FIGS. 2b and 2c, when the second tool part 114 is assembled, the outlet 176 of the tube section 174 of the heater 172 ejects proximate the temperature control surface 200 of the first layer 194.

Each of the gaskets (not shown) is constructed from a thermally insulating material. The material has a thermal conductivity that is lower than the thermal conductivity of the material that is used to construct the layers 194, 196. As such, conduction between the first layer 194 and the intermediate layer 196 is minimised. Similarly, conduction between the intermediate layer 196 and the second layer 198 is minimised due to the gasket. In addition, the orifices in the gasket between the intermediate layer 196 and the second layer 198 form a tight seal around the tube sections 174 of the heaters 172. Therefore, with the exception of tool zone 190E in which no temperature control assembly 168 is installed, no passage of fluid between the through bore 212 and through bores 216 is permitted. As such, heat transfer by way of conduction and convection is not permitted between the intermediate layer 196 and the second layer 198.

In addition to the inline air heaters 172 extending from the second layer 198 through the intermediate layer 196 to the first layer 194, a series of thermocouples 178 having elongate bodies are spring-loaded upwardly from the second layer 198 towards the temperature control surface 200 to accurately measure the temperature of the first layer 194.

As also shown in FIG. 2c, when the first tool part 114 is assembled, the signal or light path 226 extends from the apertures in the grate 192, though the chamber 204 of the first layer 194, through the bore 216 of the intermediate layer 196 and through the bore 212 of the second layer 196 towards the detector 222.

The first tool part 112 is mounted on a first, movable, part of the moulding apparatus (not shown) and fastened in position via the anchor point 136. Similarly, the second tool part 114 is mounted on a second, fixed, part of the moulding apparatus and fastened in position via the anchor point (not shown).

The mould tool 110 is assembled such that, in use, the first and second tool parts 112, 114 are brought together with the upper surface 122 of the first tool part 112 facing the surface 130 of the second tool part 114. In this way, the mould cavity portion 120 of the first tool part 112 and the mould cavity portion 128 of the second tool part 114 define a mould cavity 135 as shown in FIG. 1a.

It will be noted that each of the thermocouples 178 is connected to the controller 180 which in tum controls each of the heater switches 184 such that the desired temperature of the each of the tool zones 134 of the first mould tool 112 and each of the tool zones 190 of the second mould tool 114 can be achieved. In particular, the tools zones 134, 190 that are associated with the mould cavity portions 120, 128 will be individually controlled such that the temperature of different regions or zones of the mould cavity portions 120, 128 is optimised according to the requirements of the moulding process.

In use, air is pumped into an inlet (not shown) of the temperature control system 168 and is heated by the heater assembly 172. Control circuitry and wiring (not shown) to the heater 172 is passed through the walls of the second layers 144, 198.

The heated air travels up the elongate tube section 174 to the outlet 176 where it impinges on the temperature control surface 146, 200. Heat is thereby transferred to the temperature control surface 146, 200 and conducted to the mould cavity portions 120, 128. Air then circulates downwardly through the chambers 150, 204 into the intermediate layers 142, 196 where it passes through adjacent interior ports 164, 218 and is finally exhausted at the exhaust ports 166, 220.

It will be noted that convection of fluid into the second layers 144, 198 is not permitted due to the presence of the gasket (not shown).

Because the fluid exiting from the outlet 176 will have cooled by the time it impinges and rebounds to the intermediate layers 142, 196, it will have cooled slightly. Because the intermediate layers 142, 196 are conductively isolated from the first layers 140, 194, it will be slightly cooler. Because no conduction or convection is permitted between the intermediate layers 142, 196 and the second layers 144, 198 the second layers 144, 198 will be significantly cooler than the intermediate layers 142, 196 and, as such, any potential damage to the heater assembly 150, the control circuitry therein or the thermocouple control circuitry can be avoided. As such, all the necessary electronics and services can be installed within the second layers 144, 198 without significant problems arising from an elevated (or lowered in the case of cooling) temperature.

Furthermore, because the intermediate layers 142, 196 is conductively isolated from the first layers 140, 194, the thermal mass of the first layers 140, 194 are reduced, therefore making it easier to dynamically change the temperature of the tool face 110 using heated fluid.

The result is a highly thermally agile tool in which the temperature across the various zones can be independently and easily varied.

With reference to FIG. 2b, and as described above, one of the tool zones 134 of the first tool part 112 is an actuator or adjustment zone 134B. The temperature within the adjustment zone 134B is controlled independently of the tool zone 134A that is associated with the mould cavity portion 120. Increasing the temperature of the air supplied by the temperature control system 168 within the actuator zone 134B causes the temperature control face 146 in that zone to expand. As a result of the position of the actuator zone 134B relative to the anchor point 136, the expansion of the actuator zone 134B is primarily in the direction of arrow D, i.e. laterally with respect to the mould cavity portion 120. Conversely, decreasing the temperature of the air supplied by the temperature control system 168 within the actuator zone 134B causes that zone to contract. The primary direction of contraction is in the direction of arrow D, i.e. laterally with respect to the mould cavity portion. The lateral movement of the actuator zone 134B resulting from thermal expansion or contraction of the actuator zone 134B results in lateral movement of the mould cavity portion 120.

Connections are provided between the temperature control system 168 of the adjustment zone 134B and the controller 180 such that the temperature at the temperature control face 146 of the adjustment zone 134B is communicated to the controller 180, and the rate of flow of air and the temperature of air within the temperature control system 168 can be controlled in order to change the temperature at the temperature control face 146.

The expansion and contraction of the temperature control zone 134B causes the position of the mould cavity portion 120 of the first tool part 112 to be moved laterally relative to the mould cavity portion 128 of the second tool part 114. The primary direction of movement, in the direction of arrow D, is normal to the direction the first tool part 112 moves in during closing of the mould tool 110. The temperature control zone 134B and its associated temperature control system 168 can, advantageously, be used as a thermomechanical actuator to adjust the position of the mould cavity portion 120 of the first tool part 112 relative to the mould cavity portion 128 of the second tool part 114 in response to signals from the controller 180.

Similarly, and with reference to FIG. 2a, another of the tool zones 134 of the first tool part 112 is an actuator or adjustment zone 134C. The temperature within the adjustment zone 134C is controlled independently of the tool zone 134A that is associated with the mould cavity portion 120, and the other actuator or adjustment zone 134B. Increasing the temperature of the air supplied by the temperature control system 168 within the temperature control zone 134C causes the temperature control face 146 in that zone to expand. As a result of the position of the actuator zone 134C relative to the anchor point 136, the expansion of the actuator zone 134C is primarily in the direction of arrow E, i.e. longitudinally with respect to the mould cavity portion 120. Conversely, decreasing the temperature of the air supplied by the temperature control system 168 within the temperature control zone 134C causes that zone to contract. The primary direction of contraction is in the direction of arrow E, i.e. longitudinally with respect to the mould cavity portion 120. The longitudinal movement of the actuator zone 134C resulting from thermal expansion or contraction of the actuator zone 134C results in longitudinal movement of the mould cavity portion 120.

Connections are provided between the temperature control system 168 of the adjustment zone 134C and the controller 180 such that the temperature at the temperature control face 146 of the adjustment zone 134C is communicated to the controller 180, and the rate of flow of air and the temperature of air within the temperature control system 168 can be controlled in order to change the temperature at the temperature control face 146.

The expansion and contraction of the temperature control zone 134C causes the position of the mould cavity portion 120 of the first tool part 112 to be moved longitudinally relative to the mould cavity portion 128 of the second tool part 114. The primary direction of movement, in the direction of arrow E, is normal to the direction the first tool part 112 moves in during closing of the mould tool 110. The movement is also normal to the direction of travel caused by the expansion and contraction in the temperature control zone 134B. The temperature control zone 134C and its associated temperature control system 168 can, advantageously, be used as a thermomechanical actuator to adjust the position of the mould cavity portion 120 of the first tool part 112 relative to the mould cavity portion 128 of the second tool part 114 in response to signals from the controller 180.

As described above, the laser emitter 188, each of the grates 138, 192 and the light sensor chip 222 form part of a mould tool alignment or position detection sensor 186. In use, light is emitted from the laser emitter 188 and travels along the light pathway 224 through the first, intermediate and second layers 140, 142, 144 of the first tool part 112. The light is diffracted by each of the grates 138, 192. The diffracted light travelling along the light pathway 226 towards the light sensor chip 222. A signal corresponding to the pattern of light (the diffraction or interference pattern) received by the light sensor chip 222 is communicated to the controller 180.

Changes to the position of the first tool part 112 relative to the second tool part 114 affects the position of the grate 138 of the first tool part 112 relative to the grate 192 of the second tool part 114. This means that the pattern of light (the interference pattern) that is received by the light sensor chip 222 is altered according to the relative positions of the first and second tool parts 112, 114. Advantageously, this means that changes to the position of the mould cavity portion 120 of the first tool part 112 relative to the mould cavity portion 128 of the second tool part 114 can be detected by changes to the signal that is communicated to the controller 180 from the light sensor chip 222.

The mould tool alignment or position detection sensor 186, together with the temperature control system 168 and the controller 180 provide a cavity alignment system 228. The cavity alignment system 228 enables the position of the mould cavity portion 120 of the first tool part 112 relative to the mould cavity portion 128 of the second tool part 114 to be sensed or detected and, if required, adjusted in order to ensure that the two mould cavity portions 120, 128 are concentric. Significantly, the cavity alignment system 228 enables active, or real-time, alignment and adjustment of the mould cavity portions 120, 128, throughout the moulding process, including during cooling, which improves the accuracy of the positioning, or concentricity, of the mould cavity portions without compromising the efficiency with which moulded parts can be manufactured.

A process for aligning the mould cavity portions 120, 128 of two tool parts 112, 114 using the cavity alignment system 228 will now be described with particular reference to FIG. 3.

At step 300, the first tool part 112 is moved in a mould closure direction towards the second tool part 114 until the upper surface 122 of the first tool part 112 just touches the surface 130 of the second tool part 114.

The laser emitter 188 is activated such that light is emitted through the grate 138 of the first tool part 112 and the grate 192 of the second tool part towards the light sensor chip 222 (step 302).

A signal corresponding to the light pattern (the diffraction or interference pattern) detected by the light sensor chip 222 is conveyed to the controller 180, which determines whether the detected light pattern corresponds to the light pattern which should be detected if the mould cavity portion 120 of the first tool part 112 and the mould cavity portion 128 of the second tool part 114 are concentric (step 304).

In the event that the detected light pattern does correspond to the light pattern which should be detected if the mould cavity portion 120 of the first tool part 112 and the mould cavity portion 128 of the second tool part 114 are concentric (i.e. a calibration pattern is detected), the controller 180 initiates the moulding process (step 306).

If the detected light pattern does not correspond to the light pattern which should be detected if the mould cavity portion 120 of the first tool part 112 and the mould cavity portion 128 of the second tool part 114 are concentric (i.e. the calibration pattern is not detected), the controller 180 initiates the cavity alignment process (step 308).

In the cavity alignment process 308, the temperature control system 168 is activated to increase or decrease the temperature of the adjustment zone 134B and/or adjustment zone 134C such that the temperature control face 146 of the adjustment zone 134B expands or contacts. The expansion or contraction causes movement of the temperature control face 146 of the adjustment zone 134B and/or adjustment zone 134C in a direction that is normal or perpendicular to the mould closure direction.

It will be noted that the adjustments made by the present invention are overlaid onto the temperatures the relevant zones are set to for the moulding process. For example, zone 134B may be set to 150° C. for the moulding process, and if the cavity 120 is spaced too far to the right (viewing FIG. 2a), a positive or negative correction is applied to the 150° C. set point (for example, adjusting it to 149° C.).

During the heating or cooling of the adjustment zone, the laser emitter 188 is activated such that light is emitted through the grate 138 of the first tool part 112 and the grate 192 of the second tool part towards the light sensor chip 222.

During the cavity alignment process, a signal corresponding to the light pattern detected by the light sensor chip 222 is conveyed to the controller 180, which determines whether the detected light pattern corresponds to the calibration pattern (step 310).

If, following adjustment of the adjustment zone, the detected light pattern corresponds to calibration pattern, the controller 180 initiates the moulding process (step 306).

In this way, moulding is not possible unless the mould cavity portions are correctly aligned.

If, however, the detected light pattern does not correspond to the calibration pattern, the controller 180 re-starts the cavity alignment process (step 308). This process continues until the detected light pattern does correspond to the calibration pattern.

The invention enables a dynamic continuous relative correction of the two mould cavity portions which, in contrast to the prior art mechanical solutions, guarantees that no workpiece will be moulded unless the alignment is perfect.

FIGS. 4a and 4b show the grates 138, 192 side by side.

FIGS. 5a and 5b show the grate 138 with a different form of grate 1192. The different geometry of the grates 138, 1192 produce a different variable signal or pattern.

FIG. 6 shows a variation of the first tool part 112 having an anchor arm 136′ extending from a first corner, and a sensor arm 138′ extending from an opposite corner on the other side of the mould tool cavity portion 120. This arrangement advantageously provides increased leverage or gearing for smaller mould tools or moulds not having sufficient space for anchor points, thereby enabling micro adjustment of the position of the mould tool cavity portion on more compact moulds and/or moulds with limited available space.

It will be noted that the actuator zones 134B, 134C will tend to expand in both the X and Y directions when heated (and contract when cooled). Although this effect can be compensated for with control, it may be useful in certain circumstances to provide a degree of restraint. Referring to FIG. 7, the first tool part is shown having constraints 400, 402, 404, 406 at the mid-point of each side.

A constraint 400, also known as a top lock, is shown in more detail in FIG. 8. Each constraint 400, 402, 404, 406 is the same (apart from orientation). The constraint 400 has a first part 400a and a second part 400b mounted to respective tool parts. The parts 400a, 400b mate such that one axis of movement is locally constrained. Each constraint has an axis of constraint Cl in which it cannot move. Movement perpendicular to C1 (along C2 or C3 is permitted). As can be seen in FIG. 7, constraints 400, 402 are placed in-line with the actuator zone 134B either side of the tool along the X axis to inhibit movement along the Y axis. Constraints 404, 406 are placed in-line with the actuator zone 134C either side of the tool along the Y axis to inhibit movement along the X axis.

This means that heating/cooling of the zone 134B will primarily cause movement in the X axis, and heating/cooling of zone 134C will primarily cause movement in the Y axis. By using combinations of movement in the X and Y axes, rotation of the mould cavity portion of one mould tool relative to the mould cavity portion of the other mould tool is possible. This advantageously allows the system to be used to ensure that both symmetrical and asymmetrical mould cavity portions can be accurately aligned.

Although in the example described above, a temperature control assembly 168 is not installed in the tool zone 134E which is associated with the grate 138 and the emitter 188, it will be understood that in alternative examples of the invention, for example as shown in FIG. 9, the grate 138′ may be positioned such that a temperature control assembly can also be accommodated within the tool zone 134E′.

Referring to FIGS. 10a and 10b, a further variation of the apparatus described in FIGS. 1a to 8 is shown.

An alternative first tool part 612 is identical to the tool part 112 having a body 618 that is constructed from a metal material and has a mould cavity portion 620 defined on its upper surface 622. The profile 624 of the mould cavity portion 620 defines part of the outer surface of the workpiece. The upper surface 622 of the first tool part 612 is shown. The upper surface 622 is divided into a plurality of adjacent or tessellated tool zones 634.

One of the tessellated tool zones, the mould cavity control zone 634A is associated with the mould cavity portion 620 such that the mould cavity control zone 634A overlaps the mould cavity portion 620.

The upper surface 622 of the first tool part 612 also includes an anchor or fixing point 636 and a signal path modifier in the form of a grate 638. Each of the anchor point 636 and the grate 638 are associated with separate tool zones 634D, 634E, respectively. The tool zones 634D, 634E are spaced apart from the mould cavity portion 620 such that no part of the tool zones 634D or 634E overlaps any part of the mould cavity portion 620. The tool zone 634D is also spaced apart from the tool zone 634E.

Two of the tessellated tool zones 634B, 634C are positioned between the mould cavity portion 620 and the anchor point 636 and are actuator or adjustment zones. The actuator zone 634B is positioned laterally relative to the mould cavity control zone 634A and longitudinally relative to the anchor point 636. The actuator zone 634C is positioned longitudinally relative to the mould cavity control zone 634A and laterally relative to the anchor point 636. Neither of the actuator zones 634B, 634C overlaps any part of the mould cavity portion 120.

With reference to FIG. 10b, the body 618 of the first tool part 612 comprises a first, mould, layer 640, an intermediate, exhaust, layer 642 and a second, utilities, layer 644.

The first layer 640 includes the upper surface 622 of the first tool part 612. On the underside of the upper surface 622, a temperature control surface 646 is defined as will be described below.

The first layer 640 is surrounded by a peripheral wall 648 so as to define an enclosed volume. The first layer 640 defines a number of discrete chambers 650 which are bound by a part of the temperature control surface 646 at a first end and open at a second end 652. The chambers 650 are separated by chamber walls 654 which extend from the temperature control surface 646 to the open ends 652. As such, the first layer 640 defines a type of honeycomb structure comprising a number of discrete cell-like chambers 650. Each of the chambers 650 corresponds to a tool zone 634.

The second layer 644 includes a block 656 having a number of through bores 658 defined therein. Each of the through bores 658 contains mounting apparatus for an inline temperature control assembly 168 (as will be described below).

The intermediate layer 642 is intermediate the first and second layers 640, 644 and includes a block 660 having a number of through bores 662 defined therein. The through bores 662 are in fluid communication via internal ports 664. The through bores proximate the periphery of the block 660 are in fluid communication with the exterior of the tool via exhaust ports 666. As such, the intermediate layer 642 provides an exhaust functionality as will be described below.

The tool zone 634B (as with the previous embodiment) has an associated temperature control system or assembly 668 which is arranged to provide a fluid flow to and from the tool zone in order to alternately heat and cool the tool zone. In this embodiment, a flow guide 700 is provided which focusses the flow from the temperature control system 668 onto a sub-area 634B′ of the zone 634B.

This reduction in size of the area being influenced by the temperature control assembly provides a greater degree of fidelity. Generally, the degree of control that can be exerted is finite (for example, 0.1 degrees). By controlling the temperature of a small strip of material (i.e. of less width in the actuation direction, X), a smaller degree of movement is seen for a given increase or decrease in temperature of the mould tool material. Therefore, a greater degree of accuracy can be achieved.

Referring to FIG. 11, an example of a first tool part 512 of a mould tool 510 according to the present invention is shown. It will be understood that the mould tool 510 has a second tool part (like the tool 110) but this is not shown.

The first tool part 512 of the mould tool 510 is a lower part and has a body 518 that is constructed from a metal material and has a mould cavity portion 520 defined on its upper surface 522. The profile 524 of the mould cavity portion 520 defines part of the outer surface of the workpiece to be formed.

The upper surface 522 is divided into a plurality of adjacent or tessellated tool zones 534A, 534B, 534C. It will be noted that the mould tool may have a two-dimensional matrix of zones, e.g. 3x3 in plan. In this embodiment, each of the zones overlaps the mould cavity portion 520.

With reference to FIG. 11, the body 518 of the first tool part 512 comprises a first, mould, layer 540, an intermediate, exhaust, layer 542 and a second, utilities, layer 544.

The first layer 540 includes the upper surface 522 of the first tool part 512. On the underside of the upper surface 522, a temperature control surface 546 is defined as will be described below. The temperature control surface 546 is conformal- i.e. generally follows the shape of the profile 524 such that the mould is a constant thickness in each zone.

The first layer 540 is surrounded by a peripheral wall 548 so as to define an enclosed volume. The first layer 540 defines a number of discrete chambers 550 which are bound by a part of the temperature control surface 546 at a first end and open at a second end 552. At least part of the temperature control surface 546 comprises a reflective signal modifier 547 (FIG. 12). This will be discussed in more detail below. The chambers 550 are separated by chamber walls 554 which extend from the temperature control surface 546 to the open ends 552. As such, the first layer 540 defines a type of honeycomb structure comprising a number of discrete cell-like chambers 550. Each of the chambers 550 corresponds to a tool zone 534.

The second layer 544 includes a block 556 having a number of through bores 558 defined therein. Each of the through bores 558 contains mounting apparatus for an inline temperature control assembly 568 (as will be described below).

The intermediate layer 542 is intermediate the first and second layers 540, 544 and includes a block 560 having a number of through bores 562 defined therein. The through bores 562 are in fluid communication via internal ports 564. The through bores proximate the periphery of the block 560 are in fluid communication with the exterior of the tool via exhaust ports 566. As such, the intermediate layer 542 provides an exhaust functionality as will be described below.

A number of the tool zones 534 have an associated temperature control system or assembly 568 which is arranged to provide a fluid flow to and from the tool zone 534 in order to alternately heat and cool the tool zone 534. In this example, the temperature control system 568 has a heater assembly, an elongate tube section, an outlet and a thermocouple 578. In this embodiment, the thermocouple 578 is an ultra precise thermocouple. In other examples of the invention, a resistance temperature detector (RTD) may be provided. Each of the heater assemblies 572 is mounted within the second layer 544 within a respective through bore 558 and extends upwardly from the second layer 544 towards the temperature control surface 546. Similarly, each thermocouple 578 is spring-loaded upwardly from the second layer 544 towards the temperature control surface 546. Each of the temperature control systems 568 is connected to a controller (as with the tool 110). The controller is configured to control the air flow and heater of each zone based on feedback from the thermocouple as with the tool 110.

Each tool zone 534 includes an emitter/receiver 588. The emitter/receiver 588 comprises (for example) an optical emitter or light source such as a laser comprising a plurality of laser diodes, and a receiver for detecting a reflected signal, for example an image sensor such as a CCD or CMOS. As shown in FIG. 11, the emitter/receiver 588 is positioned within the second, utilities, layer 544.

Referring to FIG. 12, the emitter/receiver 588 is configured to emit a signal S towards the first layer 540 such that the signal S is reflected off, and modified by, the temperature control surface 546 to be reflected (at least in part) towards the receiver as modified signal S′. Specifically, the signal S is modified by the signal modifier 547. The modified signal is then detected by the emitter/receiver 588 to produce output data D.

The signal S passes from the utilities layer 544, through the exhaust layer 542 to the mould layer 540. The modified signal S′ passes from the mould layer 540, through the exhaust layer 542 to the utilities layer 544.

Each of the temperature control systems 568 is connected to a controller 580. The controller 580 includes air valves 582, by which the rate of flow of air through the temperature control systems 568 can be controlled, and heater switches 584, by which the temperature of the air within the temperature control systems 568 can be controlled. The controller also receives a data signal representative of the measured temperature from the thermocouple 578. In this way, the controller can effect closed loop control to independently control the temperature of each zone of the mould layer throughout the moulding process.

In use of the mould tool 510, the moulding pressures experienced by the mould layer 540 as well as the temperatures during the moulding cycle may cause deformation. Referring to FIG. 13, considering an area of the mould layer as a beam fixed at both ends, moulding pressure MP and thermal expansion TE may cause deformation of the mould layer away from the cavity. This is undesirable, as the mould profile 524 also deforms (altering the shape of the workpiece). FIG. 13 shows movement of the temperature control surface 546 from an initial position to a deformed position (546′).

The present invention is able to detect and correct this behaviour. The signal modifier 547 is configured such that the modified signal S′ changes with the Z position of the temperature control surface (specifically its distance from the emitter/receiver 588). This modified signal is converted to output data D which can be read and processed by the controller 580. As such, the controller 580 is provided with information relating to the deformation of the mould face as well as its temperature (via the thermocouple 578).

In response, the controller 580 can make adjustments as required. For example, should the surface 546 deform as shown in FIGS. 12/13, a negative adjustment to the required set point temperature of the controller 580 can be made. This will then cause less thermal expansion and reverse the deformation of the mould layer. Similarly, positive thermal adjustments can be made if required.

The signal modifier 547 make take a number of forms as long as it is capable of modifying a signal dependent on position. For example, the signal modifier may be a curved formation that acts as a curved, reflective surface. Therefore a signal S comprising a collimated beam of light would be reflected back as modified signal S′. The image falling on an optical sensor would change as the distance between the modifier 547 and sensor changed. In another embodiment, the signal modifier may be a series of ridges, for example in the shape of a Fresnel lens on the temperature control surface.

The signal modifier 547 may be integral with the temperature control surface (e.g. machined into it) or alternatively it may take the form of a separate component- e.g. an insert.

Because the intention of the invention is to detect deformation resulting from thermal effects, the signal modifier may be constructed (or at least partially constructed) from a material having a high coefficient of thermal expansion (CTE).

Turning to FIG. 14, and alternative form of the first tool part 512 is shown. The tool part 612 of a mould tool 610 according to the present invention is shown. The tool part 612 has a mould layer 640 with a temperature control surface 646. is the same as the tool part 512 with the exception of the temperature control surface 646. The temperature control surface 646 defines a semi-circular recess 649. The signal S is reflected off a signal path modifier 647 proximate the centre of the recess. The temperature control surface 646 in this embodiment is non-conformal.

Instead of a recess (i.e. concave), the formation may be convex.

In FIG. 15, the arrangement is identical to FIG. 12 apart from the fact that the emitter/receiver 588 is not positioned directly beneath the signal path modifier 547. Instead the signal S and modified signal S′ is passed laterally in the XY plane to a 90 degree reflector 545 where it is redirected. This configuration allows the emitter/receiver 588 to be positioned outside the tool stack if desired.

In FIG. 16, the signal S is reflected back and forth several times such that it is reflected from the signal path modifier 547 several times (a plurality of times) before hitting the sensor. The signal is progressively more modified each time, making the apparatus more sensitive to small changes in position.

Variations fall within the scope of the present invention.

The anchor 136 is typically provided in one corner of the tool. One or more of the other corners are constrained by a “loose fit” mating arrangement such as a peg and hole or slot arrangement with a clearance around the peg. This allows for initial location of the tool, but also permits some movement by the present invention.

In the example described above, the emitter 188 is provided on the moving tool part and the detector 222 is provided on the stationery tool part. It will be understood that, in alternative embodiments of the invention, the detector may be provided on the moving tool part and the emitter may be provided on the stationery tool part. Alternatively, each of the emitter and the detector may be provided on the moving tool part. In yet further embodiments of the invention, each of the emitter and the detector may be provided on the stationery tool part.

In the embodiment described above, the light patterns are formed using grates, which may be separate components within the mould tool parts or, alternatively, formed as integrated features within the mould tool parts. In alternative embodiments of the invention, the grates may be replaced by diffraction patterns.

In the embodiment described above, two adjustment zones is provided. In alternative embodiments, a single adjustment zone may be provided. In yet further embodiments of the invention, more than two adjustment zones may be provided.

The use of a temperature controlled mould tool zone to influence the position of a cavity may be enhanced by providing the actuator or adjustment zones 134B and/or 134C with a material with a higher coefficient of thermal expansion (CTE). Such a material may be layered onto the mould tool zone, or may be otherwise integrated therewith (such as an insert) to provide an increased sensitivity to the imparted temperature. This permits larger proportional displacements to be effected using the same temperature differential.

A further variant is that more than one zone may be provided as an actuator or adjustment zone. For example, looking at FIG. 2a, two pixels may be provided to the left hand side of the central zone 134A, between that zone and the anchor point 136. This enables more sophisticated control whereby one zone may be used for small scale, fine adjustment, but both zones may be used for larger adjustments in the position of the cavity 120.

In a further embodiment, the tool halves are aligned by mechanical means before the shot, and an image of the signal is taken at that point, assuming alignment is good. The system can then adjust for any deviation throughout the cycle as described above. A new image is taken at the start of every shot.

1-92. (canceled)

93. A mould tool comprising:
a first tool part defining a first mould cavity portion;
a second tool part defining a second mould cavity portion, wherein at least one of the first and second tool parts is moveable towards and away from the other of the first and second tool parts in a mould closure direction such that the first and second mould cavity portions cooperate to define a mould cavity for moulding a workpiece; and,
a cavity alignment system comprising:
a temperature control system configured to control the temperature of a first zone of the first tool part to thereby effect thermal expansion and/or contraction in the first zone of the first tool part in a direction normal to the mould closure direction;
a sensor configured to measure movement of a part of the first tool part in response to the said thermal expansion and/or contraction in the first zone of the first tool part; and,
a controller configured to control the temperature control system in response to feedback from the sensor to thereby control the position of the first mould cavity portion relative to the second mould cavity portion in a direction normal to the mould closure direction.

94. A mould tool according to claim 93, wherein the first zone of the first tool part is spaced apart from the first mould cavity portion.

95. A mould tool according claim 94, having a closed condition in which the first and second tool parts are in contact on a contact plane normal to the mould closure direction, and
wherein the said thermal expansion and/or contraction in the first zone of the first tool part is in a direction parallel to the mould contact plane.

96. A mould tool according to claim 95, in which the temperature control system is also configured to independently control the temperature of a second zone of the first tool part to thereby effect thermal expansion and/or contraction in the second zone of the first tool part; and
the sensor is also configured to measure movement of a second part of the first tool part in response to the said thermal expansion and/or contraction in the second zone of the first tool part,
wherein the said thermal expansion and/or contraction in the second zone of the first tool part is in a direction that is normal to the mould closure direction.

97. A mould tool according to claim 96, in which the direction of the said thermal expansion and/or contraction in the second zone of the first tool part is different to the direction of the said thermal expansion and/or contraction in the first zone of the first tool part.

98. A mould tool according to claim 97, in which the direction of the said thermal expansion and/or contraction in the second zone of the first tool part is normal to the direction of the said thermal expansion and/or contraction in the first zone of the first tool part.

99. A mould tool according to claim 98, wherein the second zone of the first tool part is spaced apart from the first mould cavity portion.

100. A mould tool according to claim 93, in which the sensor comprises:
an emitter that is configured to emit a signal, said signal travelling along a signal path, the signal being influenced by the position of the first mould cavity portion relative to the second mould cavity portion; and
a detector that is configured to detect the signal, the detected signal being thereby indicative of the position of the first mould cavity portion relative to the second mould cavity portion.

101. A mould tool according to claim 100, wherein the emitter is an electromagnetic emitter, the detector is an electromagnetic detector and the signal is an electromagnetic signal.

102. A mould tool according to claim 101, wherein the emitter is an optical emitter, the detector is an optical detector and the signal is an optical signal.

103. A mould tool according to claim 100, wherein the sensor further comprises:
a signal path modifier that is associated with the first tool part or the second tool part,
wherein the signal path modifier is positioned in the signal path between the emitter and the detector to thereby produce a variable signal at the detector, the variable signal being dependent on the position of the first mould cavity portion relative to the second mould cavity portion.

104. A mould tool according to claim 103, in which the signal path modifier is a first signal path modifier, the sensor further comprising a second signal path modifier, wherein
the first signal path modifier is associated with the first tool part, and
the second signal path modifier is associated with the second tool part,
wherein the first and second signal path modifiers are each positioned in the signal path between the emitter and the detector to thereby produce a variable signal at the detector, the variable signal being dependent on the position of the first mould cavity portion relative to the second mould cavity portion.

105. A mould tool according to claim 104, wherein the first signal path modifier is provided on a first surface of the first tool part and/or wherein the second signal path modifier is provided on a second surface of the second tool part.

106. A mould tool according to claim 104, wherein the first signal path modifier is formed in a first surface of the first tool part and/or wherein the second signal path modifier is formed in a second surface of the second tool part.

107. A mould tool according to claim 103, in which the first and/or second signal path modifier comprises a plurality of substantially signal-transparent regions.

108. A mould tool according to claim 107, in which the plurality of substantially signal-transparent regions are openings.

109. A mould tool according to claim 108, in which the first and/or second signal path modifiers are grates.

110. A mould tool according to claim 93, wherein the first tool part further includes an anchor point by which the first tool part is fastened to the mould tool, and wherein the anchor point and the sensor are provided on opposite sides of the first mould cavity portion.

111. A method of aligning a mould tool, the method including the steps of:
providing a mould tool as defined by claim 93;
using the sensor to sense the relative position of the first and second mould cavity portions; and
using the controller to control the temperature control system to adjust the position of the first mould cavity portion relative to the second mould cavity portion based on the sensed relative position.

112. A method of aligning a mould tool as defined by claim 111, further including the steps of:
moving one of the first tool part and the second tool part towards the other of the first tool part and the second tool part such that the first tool part and the second part are in abutting contact;
using the sensor to sense the position of the first and second mould cavity portions; and
using the controller to control the temperature control system to adjust the position of the first mould cavity portion relative to the second mould cavity based on the sensed position, thereby defining an aligned mould cavity between the first and second tool parts.
